(19) United States
(12) Patent Application Publication
(10) Pub. No.: US 2025/0257749 A1
(43) Pub. Date: Aug. 14, 2025

(54) ALL-THREAD SUSPENDING MULTIBRACKET

(71) Applicant: Dac Tuong Nguyen, Melbourne (AU)

(72) Inventor: Dac Tuong Nguyen, Melbourne (AU)

(21) Appl. No.: 19/034,594

(22) Filed: Jan. 23, 2025

(30) Foreign Application Priority Data
Feb. 6, 2024 (AU) 2024200727

(51) Int. Cl. F16B 5/02; F16B 37/06

(52) U.S. Cl. CPC F16B 5/02; F16B 37/062

(57) ABSTRACT

The present invention provides an all-thread multibracket for securely suspending different components beneath the roof or the ceiling during installation of air conditioners, ventilation ducts or smoke extractors (HVAC systems). The present intervention offers a versatile array of joining configurations, effectively replacing traditional method of using multiple brackets. The all-thread multibracket allows for effortless positioning of all-thread rods within the ceiling, beams and purlins during construction and installation.

### FIELD

The present invention relates to an enhanced all-thread multibracket specifically designed for securely mounting HVAC equipment and other components on walls or ceilings. These multibrackets offer a robust and sturdy attachment, ensuring precise and secured placement of the equipment.

### BACKGROUND

The installation of air conditioners, ventilation ducts and smoke extractors (HVAC systems) typically involves suspending different components and equipment beneath the roof or on the ceiling using various joining brackets. Currently, civil engineers, technicians and installers encounter the need to use many different types of brackets to accomplish this task. The prior art thread brackets, such as those as illustrated in FIGS. 12 to 18, typically exhibit a bottom-down configuration (as in FIG. 12), attachment to steel beams (as in FIG. 13), Z-bracket design (as in FIG. 14), linkage to purlins (as in FIG. 15), vertical anchor (as in FIGS. 16 and 17), and linear connecting capability (as in FIG. 18).

These currently available thread brackets encompass a variety of configurations and are currently used in different applications within the construction and building industry. Each of these brackets offers only a part of the task requirement to suspend HVAC components onto ceilings and others. The prior art brackets must be used together to complete the task, thus limiting effectiveness, efficiency and safety assurance.

Any reference herein to known prior art does not, unless contrary indication appears, constitute an admission that such prior art is commonly known by those skilled in the art to which the invention relates, at the priority date of this application.

### SUMMARY

The present invention provides an innovated all-thread suspending multibracket designed to securely suspend HVAC components from the building's roof, ceiling or wall. This versatile multibracket offers a wide range of joining configurations, including linear connection, attachment to purlins and vertical fixation. With this novel solution, HVAC installations can be done more easily, quickly and safely in many situations, placement and attachments as required.

For HVAC installations, there can be many types of joining configurations required at the same time, such as vertical fix, bottom down connection or Z connection. Each current prior art bracket is designed to support only one specific joining configuration. Consequently, engineers and technicians must carry numerous types of brackets, which can become frustrating when a specific configuration is required and the necessary particular bracket is unavailable. The all-thread multibracket is designed to address this issue by accommodating multiple joining configurations instantly in one multibracket.

Our all-thread multibracket is made of a rectangular steel plate. The plate consists of two parts with the first part having an L shape and the second part a U shape. There are 3 nuts or rivet nuts of M10 size and 4 holes of 6 mm in diameter on the bracket.

The all-thread multibracket has two concentric threaded holes, making it suitable for connecting two threaded rods or devices to steel beam, as well as attaching a thread rod to a steel purlin.

The all-thread multibracket also features two pairs of perpendicular threaded holes, enabling it to connect a threaded rod and a wall, steel bar or timber.

Depending on the requirements, the all-thread multibracket can be made of mild steel or stainless steel to offer the mechanical strength and anti-corrosion characteristics required. Steel is selected due to its popularity in civil engineering industry.

The all-thread multibracket can be manufactured at different thickness to match the required strength specifications. A 3 mm thick all-thread multibracket can hold up to a 200 kg load.

The all-thread multibracket can be manufactured in various sizes to match the dimensions of connected devices and meet the necessary strength requirements.

An example of our all-thread bracket is made from a 3 mm thick mild steel plate. The L shape section is 25 mm wide and 78 mm high. The U shape section is 53 mm wide and 25 mm high.

Our all-thread bracket can be used not only for suspending components in HVAC installation but also for installing household appliances.

### BRIEF DESCRIPTION OF THE DRAWINGS

A detailed description of a preferred embodiment will follow, by way of example only, with reference to the accompanying figures of the drawings, in which:

FIG. 0 provides all the dimensions, sizes and measurements of all parts of an embodiment of an all-thread multibracket;

FIG. 1 illustrates a rendered front view of an embodiment of an all-thread multibracket without rivet nuts;

FIG. 2 illustrates a rendered front view of an embodiment of an all-thread multibracket with rivet nuts;

FIG. 3 illustrates a rendered back view of an embodiment of an all-thread multibracket;

FIG. 4 illustrates the all-thread multibracket using standard nuts instead of rivet nuts;

FIG. 5 illustrates an example of the all-thread multibracket connecting with two threaded rods;

FIG. 6 illustrates an example of the all-thread multibracket connecting a threaded rod to a steel beam;

FIG. 7 illustrates an example of the all-thread multibracket connecting a threaded rod to a steel purlin;

FIG. 8 illustrates an example of the all-thread multibracket connecting a threaded rod to the bottom of HVAC equipment;

FIG. 9 illustrates an example of the all-thread multibracket connecting a thread rod to a steel bar;

FIG. 10 illustrates an example of the all-thread multibracket connecting a thread rod to the wall;

FIG. 11 illustrates an example of the all-thread multibracket connecting a threaded rod to the ceiling;

FIG. 12 illustrates a prior art bracket connecting a threaded rod to the ceiling;

FIG. 13 illustrates a prior art bracket connecting a threaded rod to a steel beam;

FIG. 14 illustrates a prior art bracket for Z-type hanging;

FIG. 15 illustrates a prior art bracket connecting a threaded rod to a C-purlin;

FIG. 16 illustrates a prior art bracket horizontally connecting a threaded rod to the wall;

FIG. 17 illustrates a prior art bracket vertically connecting a threaded rod to the wall; and

FIG. 18 illustrates a prior art bracket connecting two threaded rods.

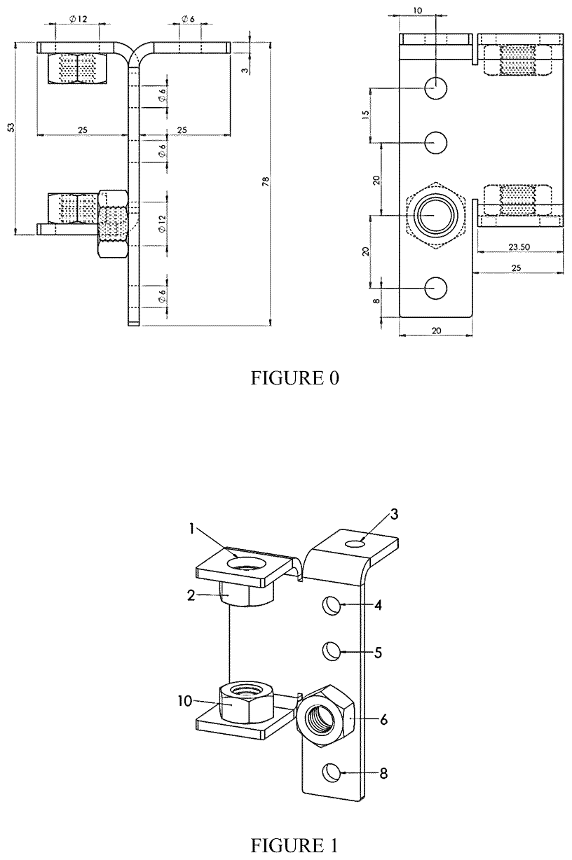

### DETAILED DESCRIPTION

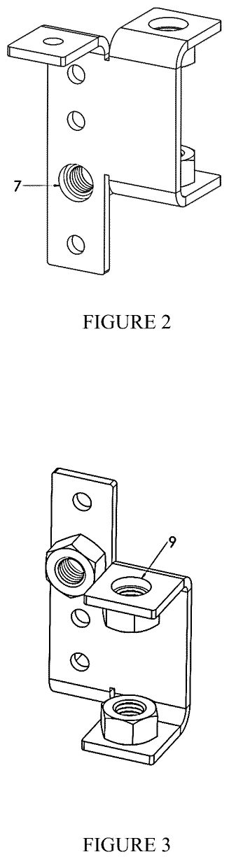

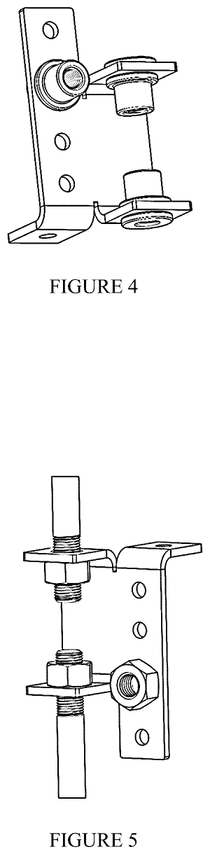

FIGS. 1 to 11 showcase the all-thread multibracket, meticulously designed to ensure the secure mounting of HVAC equipment on walls or ceilings during installation. Crafted from high-quality metal, this bracket features a precisely determined thickness, guaranteeing strength and reliability. Its ingenious design enhances its functionality and versatility.

Our all-thread multibracket can be made from a 3 mm-thick rectangular steel plate. The plate measures 103 mm in length and 45 mm in width. To create the shape of the multibracket, one can make two cuts on the plate from the two 45 mm shorter sides of the plate at the top and the bottom. The two cuts are positioned 25 mm from the left longer side of the plate. The two cuts measure 25 mm long. After these cuts, the two sections on the left side of the cuts (one on the top and the other on the bottom) are bent 90 degrees to the front, forming a U-shaped structure that is 53 mm in width and 25 mm in height. On the right side of the cut, the top section is bent 90 degrees to the back. This results in the right side of the steel plate forming an L-shaped structure that is 78 mm in height and 25 mm in width.

There are 3 special holes (1, 7 and 9) in FIGS. 1-3 that are 12 mm in diameter. These 3 holes make up two pairs of perpendicular holes (1-7 and 7-9) and one pair of concentrical holes (1-9). An M10 standard nut is welded on top of each hole. However, other hole and nut sizes can also be present on the multibracket as well for different requirements. The standard nut will be required to weld on the bracket. To avoid welding, standard nuts can be replaced by rivet nuts.

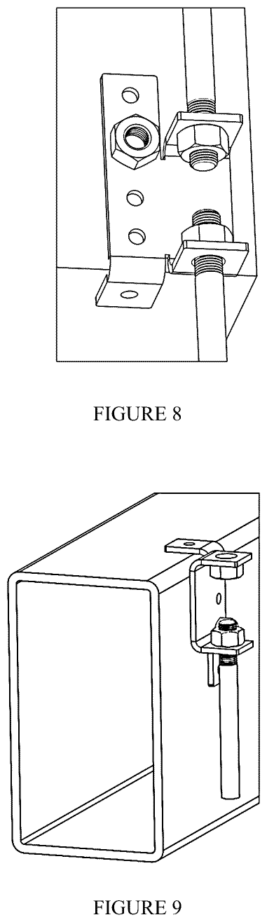

The multibracket is ingeniously designed with four M6 circular holes (3, 4, 5, 8 in FIG. 1) strategically placed to facilitate easy fixation to walls, beams, purlins, and timbers using screws, as depicted in FIGS. 8 to 11. Each circular hole has a diameter of 6 mm. These four holes are placed on the L-shaped structure of the multibracket. Hole 3 is on the horizontal section of the L-shaped structure and the other three holes (4, 5 and 8) are on the vertical section of the L-shaped structure. Specifically, hole 3 is at the centre of the horizontal section of the L-shaped structure. The other 3 holes (4, 5 and 8) are lined up 10 mm from the right longer edge of the vertical section of the L-shaped structure. From the bottom up, in order, hole 8 is 8 mm from the bottom edge of the vertical section of the L-shaped structure, hole 5 is 30 mm from hole 8 and hole 4 is 15 mm from hole 5.

Illustrated in FIG. 5, using its two concentrical nuts (2 and 10), the all-thread multibracket can be used to connect two threaded rods to form a rod with the expected length.

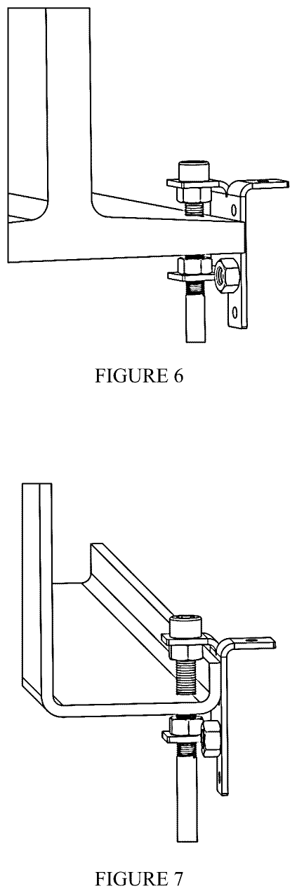

In FIG. 6, the all-thread multibracket demonstrates its exceptional utility by seamlessly connecting a threaded rod to a steel beam, offering a robust and dependable solution for structural support. An M10 bolt is connected to nut 2. An M10 threaded rod is connected to nut 10.

Illustrated in FIG. 7, the all-thread multibracket is used to connect a thread rod to a steel purlin, ensuring sturdy and reliable support. Similar to FIG. 6, nut 2 is connected to a M10 bolt and nut 10 is connected to a M10 threaded rod.

FIG. 8 showcases the all-thread multibracket's ingenuity as it effortlessly connects a threaded rod to the bottom of HVAC equipment, ensuring a secure and stable mounting solution. Two M10 threaded rods are connected to nuts 2 and 10.

Illustrated in FIG. 9, the all-thread multibracket is used to connect a threaded rod to a steel bar or timber stud. To use our all-thread multibracket in this case, first we place the multibracket to the edge of the timber stud with the L-part touch the surface of the timber stud. Second, we fix the multibracket to the timber stud by nailing or screwing the four holes (3, 4, 5 and 8 in FIG. 1) and the multibracket is ready to use. One or two threaded rods can be connected to nuts 2 and 10. As an example, we connect a threaded rod to nut 10 in FIG. 9.

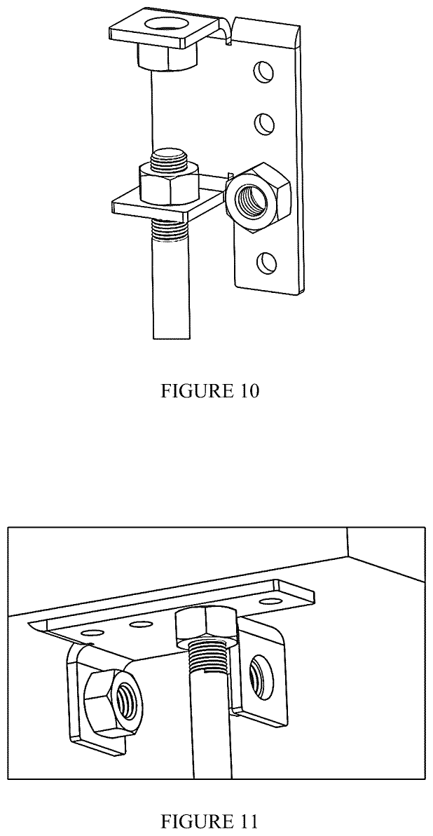

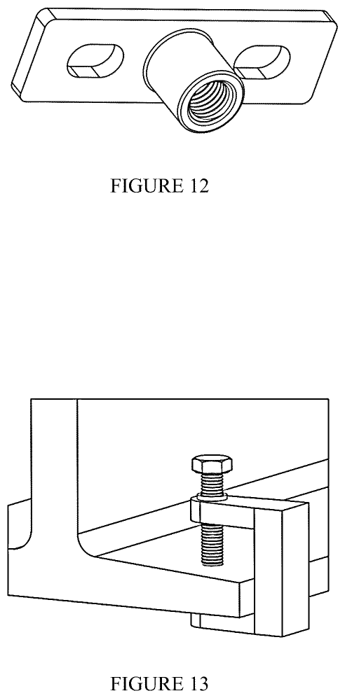

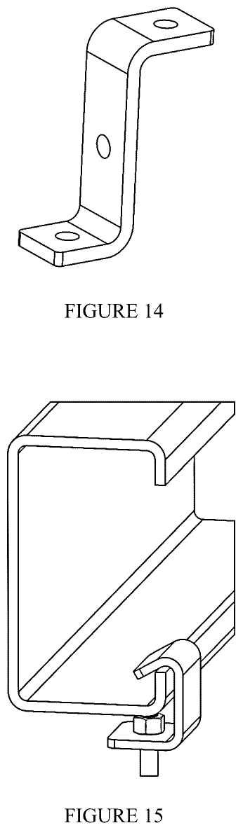

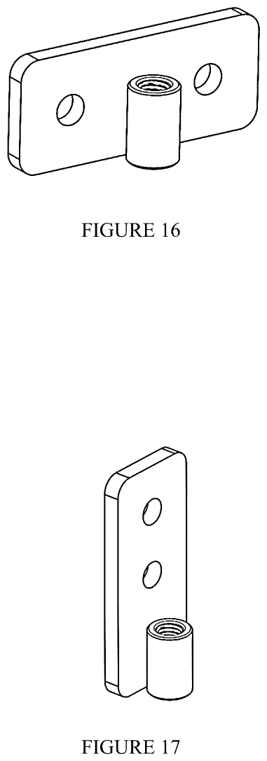

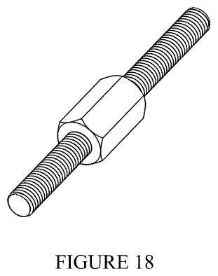

Illustrated in FIG. 10, the all-thread multibracket is used to connect a threaded rod to the wall after cutting off the 25 mm bent part of the L shape. As a result, hole 3 is also removed from the multibracket. Three holes (4, 5 and 8) were screwed with M6 screws to fix the multibracket to the wall and then a threaded rod can be connected to nut 10. In FIG. 11, the all-thread multibracket serves its purpose by effectively connecting a threaded rod to the ceiling. The shorter part of the L-shape was removed, similar to FIG. 10. Three holes (4, 5 and 8) were screwed with M6 screws to fix the multibracket to the ceiling and then a threaded rod can be connected to nut 6.

1. An all-thread multibracket for equipment placement and mounting, said bracket having a distinctive zigzag configuration comprising of a U-shaped section and a L-shaped section.

2. An all-thread multibracket as claimed in claim 1 wherein the U-shaped and L-shaped sections having the said or similar dimensions.

3. An all-thread multibracket as claimed in claim 1 wherein the said bracket has the said nuts and holes at the said locations or similar locations on the said bracket.

4. An all-thread multibracket as claimed in claim 1 wherein the said nuts could be standard nuts or rivet nuts.

5. An all-thread multibracket as claimed in claim 1 wherein the said nuts are welded onto the said bracket.

6. An all-thread multibracket as claimed in claim 1 wherein the material of the said bracket is mild steel, stainless steel or a similar metal.

7. An all-thread multibracket as claimed in claim 1, said bracket having the said or similar functions and usage per the specification description.
